(19) United States
(12) Patent Application Publication
(10) Pub. No.: US 2025/0328873 A1
(43) Pub. Date: Oct. 23, 2025

(54) SYSTEM AND METHOD FOR USING ARTIFICIAL INTELLIGENCE AND ONBOARD DIAGNOSTICS TO IDENTIFY USABLE SALVAGE AUTO PARTS AND TO OPTIMIZE AUTOMOTIVE PARTS DISTRIBUTION

(71) Applicant: Paul Redding, Monkton, MD (US)

(72) Inventor: Paul Redding, Monkton, MD (US)

(21) Appl. No.: 18/939,666

(22) Filed: Nov. 7, 2024

Related U.S. Application Data
(60) Provisional application No. 63/635,040, filed on Apr. 17, 2024.

(51) Int. Cl. G06Q 10/30; G06Q 30/0601

(52) U.S. Cl. CPC G06Q 10/30; G06Q 30/0633; G06Q 30/0641

(57) ABSTRACT

A method and system for optimizing the identification, documentation, and distribution of OEM and reusable salvaged auto parts enables more efficient and cost-effective repair of subject vehicles. The system includes using onboard diagnostics applied to salvaged automobiles to automatically determine and electronically document electronic assemblies that qualify as reusable and then using artificial intelligence algorithms in real time to determine, order, and initiate distribution of combinations of OEM and salvage parts previously determined to be reusable.

### REFERENCE TO RELATED APPLICATIONS

This Application claims the priority of provisional patent application 63/635,040 filed Apr. 17, 2024 entitled System and Method for Using Artificial Intelligence and Onboard Diagnostics to Identify Usable Salvage Auto Parts and to Optimize Automotive Parts Distribution.

### BACKGROUND OF THE INVENTION

This invention relates generally to the use of (1) OBD on salvage automobiles to determine available usable parts which may be thoroughly documented electronically and (2) artificial intelligence algorithms for determining, automatically ordering, and distributing a combination of new and salvage parts needed for repair of a subject vehicle.

The use of previously used auto parts when making repairs of a subject vehicle has the obvious advantage of being less expensive than simply purchasing and installing a new part, also referred to as an Original Equipment Manufactured part or just an OEM part. This efficient use of salvaged vehicles provides one of the most significant advantages of used auto parts—cost effectiveness. Compared to purchasing new OEM (Original Equipment Manufacturer) parts or even aftermarket parts, salvage parts are often available at a fraction of the cost. This can result in significant savings for vehicle owners, especially for relatively new vehicles that not available for normal driving while awaiting parts, older vehicles, or repairs that are not covered by insurance.

Further, it is known that previously used parts may be obtained from vehicles in a salvage yard. Unfortunately, there has previously been no effective system of identifying which vehicles in a salvage yard may possess a functional part that is needed for a present repair task. Identifying functional parts that may be harvested has been random at best. For instance, a needed auto part may be taken from a salvage vehicle and installed in the vehicle-in-need-of-repair only to find that the harvested auto part does not work.

Therefore, it would be desirable to have a system and method for using On-board diagnostics (OBD) to determine and electronically document usable automotive parts from salvaged automobiles and then to determine, preferably using artificial intelligence algorithms, and automatically order/distribute combinations of reusable and OEM parts needed for a repair of a subject automobile.

### SUMMARY OF THE INVENTION

Like much of industry, the automotive sector is affected by lingering supply chain impacts from the COVID-19 pandemic. The shortage, specifically of semiconductors, has persisted, exacerbated by the increase in demand for consumer electronics and telecommunications. These issues have led to production slowdowns and even factory shutdowns for many automakers. Semiconductors are critical components in modern vehicles, used in everything from engine control units to entertainment systems. The Advanced Driver Assistance Systems (ADAS) Electronic Control Units (ECUs) have expanded the use of complex electronics in vehicles, further increasing the demand for semiconductors. These external events are not the only challenge automakers are facing.

The transition to electric vehicles presents a separate challenge for the automotive supply chain. The significant difference in the powertrains creates a dual manufacturing need-that of the old technology of Internal Combustion Engines (ICE) and of the new battery and electric motor technology powering Electric Vehicles (EVs). Support for the older technology while developing the new one creates resource competition. The question of when to stop supporting the existing ICE fleet is a difficult one to answer. Recent news has indicated adoption of EV is stagnating and strategic decisions for investment in new verses old is very topical. This supply chain disruption is an internal issue for manufacturers.

In response to the semiconductor shortage automakers are reevaluating their procurement strategies for complex electrical parts. One of these tactics is to diversify their supplier base including procuring parts from the automotive salvage yard sector. However, it is essential that the salvaged parts are verified for quality and reliability before harvesting to ensure safe and effective repairs. The use of AI can assure this quality while presenting new market opportunities for used complex electrical automotive parts, which have traditionally been discarded during the salvage vehicle crushing process for scrap metal value.

This process of obtaining verified used complex electrical parts has the added benefit of creating a circular economy and making recycling more sustainable. The process is not really “recycling”, but the better alternative of “reuse”. When something is recycled, it undergoes a process where it is broken down into raw materials which are then used to create new products (a significant use of new energy). Reusing involves using an item again in its OEM parts original form or after minor refurbishment, without breaking it down into raw materials and the corresponding use of energy. Reusing auto parts helps extend the lifespan of components, reduces waste, and allows the energy embedded in the part to continue to provide benefit and avoid the depletion of natural resources that recycling or new manufacturing require.

Having a system for determining functional user salvaged parts before defaulting to using OEM parts when making legal repairs brings a whole new level of cost-effective vehicle maintenance and repair.

Salvage auto parts are OEM parts removed from vehicles that are the same make and model as the vehicle needing repair. This ensures compatibility and fit, as these parts were designed to work seamlessly with the original vehicle specifications.

By participating in the salvage auto parts market, OEM dealers, independent repair shops and consumers contribute to a circular economy model, better described as closed loop recycling—where resources are reused, rather than discarded. This helps to extend the lifespan of automotive components, reduce waste generation, and promote sustainable consumption practices.

Overall, salvage auto parts offer a cost-effective, environmentally friendly alternative to purchasing new parts, providing benefits in terms of affordability, availability, compatibility, and sustainability. However, resistance to reuse of complex electrical parts is well established in the auto parts supply chain. In the past, it was common to see notices at parts suppliers or on their invoicing—“No Returns on Electrical Parts”. This was for good reason, verifying that an electrical part was performing its function is difficult to know when visually examining the part. Bench testing of the part was difficult and cost prohibitive.

With AI, these quality challenges can be met. In-car verification of complex electrical components is possible with the use of the Onboard Diagnostic (OBD) functionality through a Vehicle Controller Interface (VCI) working with a cloud-based software application. This process begins at the salvage yard during initial intake.

With alternating current and battery power, the user plugs the VCI into the OBD port and puts the vehicle into diagnostic mode. From the VCI, the user opens connection to the robot, initiating a vehicle scan. Reporting on the various VCI's are recorded and saved, this process creates a unique identifier, establishing the Pedigree Part Number (PPN) for every complex electrical component that meets the OEM quality requirements. This PPN is cross referenced to the part name, vehicle Year, Make, and Model (YMM), Vehicle Identification Number (VIN), Engineered Part Number (EPN), Service Part Number (SPN) and current list price of the new part.

An EPN is typically assigned during the design and development phase of a vehicle or component and may not always be visible to customers or end-users. A SPN serves as a unique identifier for a part that customers or service technicians may need to order for vehicle repairs or servicing. SPNs are often used by dealerships, repair shops, and parts distributors to catalog and sell replacement parts to customers. SPNs are typically designed to be more user-friendly and easily recognizable than engineering part numbers, making it easier for non-technical personnel to identify and order the correct parts. Crosslinking these numbers is an important part of the quality process. Often one or the other of these numbers, but rarely both, are on the part marking labels, etchings or engraving.

Creating this data set of cross-referenced items mentioned above provides the basis for further enhancement and improvement of auto parts distribution. It allows quick and easy identification of working complex electrical parts within a recycled vehicle and the linking of part information to Diagnostic Trouble Codes (DTCs). Utilizing the data set, we can develop advanced solutions to streamline the listing process for Pedigreed Parts on third-party marketplaces, significantly enhancing efficiency and sales potential for the salvage yard. Once the vehicle is scanned the salvage yard will have a set of parts with all corresponding data:

### Electrical Part Pass/Fail Status

### OEM List Pricing

PNP
YMM
EPN
SPN
Part Name
VIN

This packet of data can be seamlessly uploaded to various selling platforms in the used automotive parts space-termed “The One Click List”. The commercial platforms may include but is not limited to:
APU
CCC TRUE Parts
Pinnacle
OE Connect
eBay

The second distribution improvement is at the repair facility, whether an OEM dealer or an independent repair shop. By collecting parts data and using machine learning algorithms for natural language processing and predictive analytics, a process of linking DTC codes to the parts that can affect a successful repair is created. The algorithm will understand the text data in the repair procedure describing the part requirements and will link that part name to a data set or database. him

This will result in a list of part numbers for the repair. This process will occur at car side while the technician is scanning the vehicle. The application will link the parts list to existing vendor catalogues, whether new OEM, used or aftermarket. This will allow parts ordering to occur at car side. Partnering with the various channels of parts distribution will provide the repair technician with many alternatives to the vehicle owner allowing the repair facility to capture customers at various points on the price elasticity curve. Pragmatically, the data set will include part identifying information, price, and a location such that an immediate purchase or purchase order may be generated, such as for purchasing the product in real time from a salvage yard or, eventually, from a centralized location where the invention described herein is implemented

As the database increases the predictive analytics will improve the process by learning which Year/Make/Model (YMM) results in what types of repairs require what part. Further, predictive maintenance algorithms and data from sensors embedded in vehicles are operative to predict when specific parts are likely to fail. This allows parts channels to proactively stock and distribute replacement parts, reducing vehicle downtime and further improving customer satisfaction.

Accordingly, the present invention includes combination of a vehicle controller interface (VCI) with onboard diagnostics (OBD) that generate diagnostic trouble codes (DTC) as each of a plurality of vehicles is analyzed such that a data set of still-functional salvage parts (i.e., available for re-use) is built in real time as salvage vehicles are electronically analyzed such that a vehicle-in-need-of-repair, through application of artificial intelligence modules, can be fixed according to an accessed repair procedure. Therefore, especially configured electronic devices or computer would be required to perform the recited combination of diagnostics, data set building, diagnostics of a vehicle-in-need-of-repair, and then locating and ordering combination of salvaged and OEM parts such that the repair is made cost-effectively to the consumer and profitably to the mechanic.

Therefore, a general object of this invention is to provide a system and method that uses onboard diagnostics (OBD) on salvage automobiles to determine available usable parts which may be thoroughly documented electronically.

Another object of this invention is to provide a system and method, as aforesaid, that uses artificial intelligence algorithms for determining, automatically ordering, and distributing combinations of OEM and salvage parts needed for repair of a subject vehicle.

Still another object of this invention is to provide a system and method, as aforesaid, that incrementally builds a data set (i.e., a database) of still-functional salvage parts, including identification of a cost and location where a respective still-functional salvage part may be purchased as part of a repair procedure.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a flowchart depicting the identification and verification of salvage auto part methodology according to a preferred embodiment of the present invention;

FIG. 2 is a flowchart depicting the verification of installed electrical auto parts according to the present invention;

FIG. 3 is a flowchart depicting a repair methodology using identified and verified salvage parts and OEM parts according to the present invention;

FIG. 4 is a block diagram illustrating a general overview of the electronic components of a system according to the present invention connected to the Internet;

FIG. 5 is a block diagram illustrating the organization of a data set populated with aspects of automobile components available for lookup by the software application according to the present invention and for use by the artificial intelligence aspect of the present invention; and

FIG. 6 is a block diagram illustrating usage of the software application according to the present invention.

### DESCRIPTION OF THE PREFERRED EMBODIMENT

A system and method according to a preferred embodiment of the present invention will now be described with reference to the accompanying drawings.

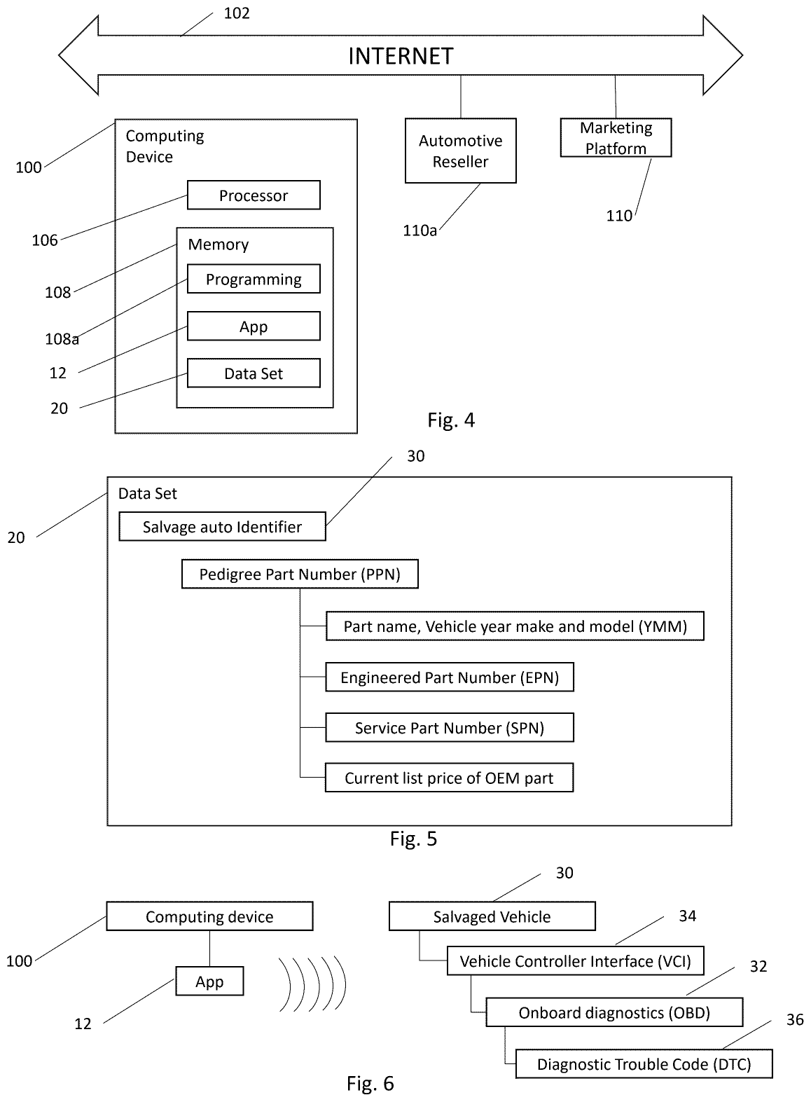

As shown specifically in FIG. 4, the present invention may be referred to as a system 10 that includes a mobile application 12 (i.e., an App”) although remote and third-party platforms may be electronically accessed via a wide area network such as the Internet 102. Preferably, the app is configured to run (i.e., to be executed by) on a mobile electronic device 100 such as a smart phone, laptop, desktop computer, or the like. Importantly, however, the personal electronic device 100 may be in data communication with other electronic devices such as the onboard diagnostics (OBD) of a salvaged vehicle (such as in a junkyard) or another OBD associated with a vehicle-in-need-of-repair. To be complete, the electronic device 100 may include a microprocessor 106, controller, or the like and a non-volatile memory 108 that includes and is configured to store program instructions 108a and data 108b as will be described in further detail later. It is understood that the type of data may include salvage vehicle identifiers, component part identifiers, a repair procedure, and other data types. Further, a data set 20 is a data structure that may be accessed and stored in the memory 108. In use, the memory 108 may be accessed using a graphic user interface, touchscreen, and the processor 106, executing predetermined programming instructions 108a, is capable of accessing the data set 20 and writing still-functional salvage part information to a data set 20 stored in memory 108.

As that shown in FIGS. 5 and 6, a general object of the present invention is to provide a system and method that uses onboard diagnostics (OBD) on salvage automobiles 30 to determine available usable parts which may be thoroughly documented electronically. The data set 20 may be populated as a user utilizes the app 12 to analyze a plurality of salvage vehicles 30. Preferably, the app 12 is configured for data communication with the onboard diagnostics (OBD) 32 of the plurality of salvage vehicles 30. In fact, it is contemplated that the app 12 may include a touchscreen or manual button that simply starts and repeats the method of analysis over again until all of the electrical component parts or systems of a respective salvage vehicle 30 have been analyzed for functionality and until all of the salvage vehicle for the database have been analyzed. In other words, the app 12 may direct a respective OBD 32 to search repeatedly until all of the electronic assemblies of an individual salvaged vehicle 30 have been analyzed and recorded. Specifically, whenever an electronic or electrical component part “passes” (i.e., is found to be functional), a suitable part identifier is recorded in the data set 20 with sufficient detail so as to be later located by a user seeking to order still-functional salvage and OEM parts wherewith to perform a repair procedure. A detailed listing and explanation of identifiers of the salvage vehicle being analyzed and of each functional component part or assembly was given in the summary above and is incorporated by reference herein. An OBD 32 determines what component parts of an automobile need to be repaired or replaced by reading any diagnostic trouble codes (DTC) 36 that may have been set by the respective OBD 32.

It is understood that, at least initially, the user of the app 12 may be an owner or employee of a salvage/junkyard who may connect to a respective OBD 32 of a respective salvage vehicle 30 such that each electronic component part or system of a respective salvage vehicle 30 (and then the entire plurality of vehicles) are analyzed and all components that “pass” a test of functionality will be added to the data set 20—so as to be available during a later repair procedure on a vehicle-in-need-of-repair as will be described in more detail later.

In an embodiment, the processor 106 is configured to be connected to and in data communication with a vehicle controller interface (VCI) 34 of an OBD 32 of a respective salvage vehicle 30 so as to identify and evaluate the functionality of an electrical component part of the respective salvage vehicle 30. This may involve a data cable connecting the computing device to the respective VCI 34 or may involve wireless connections (FIG. 6).

The VCI 34 is configured to determine if the component part or system being analyzed is functional so as to be reusable and, if so, directing the processor| to store appropriate part data or identifier associated therewith into the data set 20. More particularly, the respective VCI 34 may include predetermined criteria for determining whether a component part passes or fails the functionality test.

It is understood that a plurality of app's 12 running on a plurality of electronic devices 100 may be used throughout and across the country to determine and propagate the data set 20 representing all or a portion of all the used component parts that are available to be ordered and used in repair procedures nationwide. Pragmatically, the data set 20 from cach app 12 may be uploaded to a master data set 20 which may then be accessed by automotive shops and technicians who routinely order parts necessary to accomplish repair procedures. For instance, a technician may have been hired to fix a faulty passenger window sensor or actuation button and can access the master data set 20 to determine availability of the needed component part. In fact, the needed part can be ordered immediately using the app 12. Only if no salvage part is available does the technician need to order an Original Equipment Manufactured (OEM) part. Accordingly, the automotive technician may order a combination of 1) functional reusable parts and 2) OEM parts that are needed to carry out a necessary repair procedure.

In a related aspect, the master data set 20 may be uploaded to and published by a third-party platform 110, such as via the Internet 102, from which technicians are able to view all salvaged component parts that are available for purchase and distribution and by which vehicle repairs may be accomplished. It is understood that the platform may refer to a marketing platform 110 and, specific to the present application the marketing platform 110 may be an auto parts reseller 110a, and a website of a retail store, or combinations thereof. The app 12 may be configured to transmit updates to the third-party platform 110 at each occurrence of a new part being added as functional or according to another scheduled update procedure.

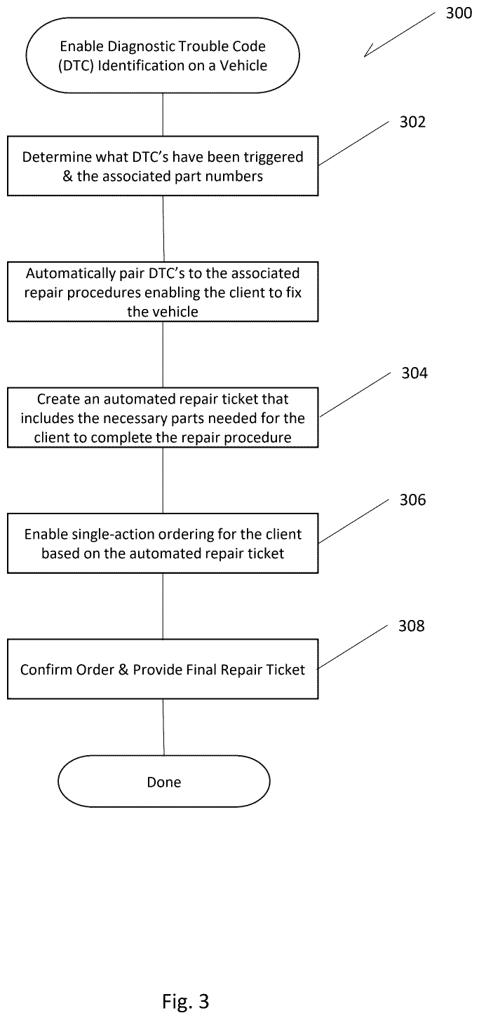

Another critical aspect of the present invention is to provide functionality for an automotive repair or technician to carry out a repair procedure in a cost-effective manner. FIG. 3 is a flowchart illustrating operation of a repair procedure according to the present invention. More particularly, the electronic device 100 executing the app 12 may connect to the onboard diagnostics (referred to as “another OBD”) such as with a cable, near field communications (NFC), Bluetooth, or other wireless protocol. This functionality and step in the inventive methodology is for the purpose of determining what component parts, system or systems are needed in an automobile that is in need of repair. More particularly, the OBD may show specific diagnostic codes indicative of a component part that needs to be repaired or replaced. The app 12 is configured to outline a complete repair procedure, including a listing of component parts, the order of replacement, and other details. Then, the repair technician may order and purchase all of the component parts that will be necessary to carry out the repair procedure. Traditionally, a repair technician calls or visits a local “parts house” to order all of the OEM parts needed for the repair. By contrast, the present invention provides the means for a technician to determine the availability of still-functional salvaged parts or systems ready to be reused. If there is no suitable salvage parts in the data set 20, then an OEM part may be ordered. Accordingly, the technician may place an immediate order for a combination of still-functional salvaged parts and OEM parts—which saves both time and money.

In another aspect of the invention, the app 12 may be configured to “predict” when predetermined component parts on an otherwise functional automobile will fail. This determination enables a technician, such as a fleet manager of a business having a plurality of automobiles, to order corresponding parts, whether still-functional salvaged parts or OEM parts prior to the predicted date of failure. Again, this functionality improves the time and cost efficiency of such repairs. It is understood that artificial intelligence algorithms may be utilized to “predict” dates of part failures.

In a critical aspect of this invention, artificial intelligence algorithms may be utilized not only to predict when a part will fail but for use in determining what repair is needed, what repair needs to utilized new parts and which salvage parts that may be available but not unacceptably close to a failure, and a step-by-step documentation of the repair to be followed by a technician.

Artificial intelligence (AI) has grown to encompass a variety of technologies that allow machines to perform tasks typically requiring human intelligence. This broad category can be broken down into distinct types, each with unique characteristics and applications. Understanding these types helps highlight the foundational role that neural networks, large language models, and training algorithms play in the AI landscape.

There are multiple types of artificial intelligence—each characterized by its own methodology and algorithms, the most simple to the more complex types being surveyed below:
Reactive AI: This is the most basic type of AI, which solely reacts to inputs without memory or the ability to learn from past experiences. It excels at specific, rule-based tasks, such as IBM's Deep Blue, a chess-playing program.
Limited Memory AI: This type can store past data to inform current actions. Most modern AI applications fall under this category, from recommendation systems in e-commerce to self-driving cars that use historical data for decision-making.
Theory of Mind AI: A more advanced but largely theoretical AI, this category seeks to understand human emotions, beliefs, and intentions, aiming to interact more naturally with people. Currently, this type of AI is mostly seen in experimental development.
Self-Aware AI: The final stage, yet to be achieved, would allow machines to have consciousness, self-awareness, and independent reasoning, making them fully autonomous agents. While intriguing, it remains largely speculative.

Neural networks are the backbone of most modern AI applications, especially those that mimic human intelligence in tasks like language processing, image recognition, and decision-making. Comprising interconnected nodes called neurons, neural networks function similarly to the human brain by processing data through multiple layers. The first layer receives raw input, while cach subsequent layer refines and interprets this input, allowing the network to “learn” patterns and relationships within data.

Various types of neural networks are designed for different tasks. Convolutional Neural Networks (CNNs), for example, are used for image recognition, while Recurrent Neural Networks (RNNs) excel at handling sequences, making them ideal for language and time-series data. These networks learn by adjusting the weights of connections between neurons, which requires large datasets and specialized algorithms for training.

Large Language Models (LLMs) are a subset of neural networks trained specifically on language tasks. These models, such as OpenAI's GPT series, Google's BERT, and others, are designed to understand, generate, and manipulate human language. LLMs typically rely on Transformer architectures that allow for parallel processing, enabling them to handle extensive datasets and complex language structures efficiently. By analyzing massive amounts of text data, LLMs learn to predict word sequences, understand context, and generate coherent responses, making them invaluable for tasks like translation, summarization, and conversational AI.

Training both neural networks and large language models involves algorithms that fine-tune the model's parameters to optimize performance. These algorithms, particularly those based on backpropagation and gradient descent, calculate the difference between predicted and actual outcomes, adjusting model parameters to minimize errors. Stochastic gradient descent (SGD) and Adam are common training algorithms used to optimize learning. For neural networks, the process can be time-consuming, as it requires passing data through multiple layers, calculating errors, and iterating the process thousands of times until the model “learns” effectively.

To summarize, the development of neural networks, LLMs, and sophisticated training algorithms has enabled AI to expand its capabilities significantly, making it possible to tackle complex, human-like tasks with increasing accuracy and efficiency.

In use, the present invention is directed to an electronic system and corresponding method in which car or truck repairs can be streamlined to include both OEM parts as well as still-functional parts cannibalized from salvaged vehicles such that the overall cost of a vehicle repair is decreased while the profit margin of a dealer or mechanic is increased. It is critical to understand that onboard diagnostics (OBD) and diagnostic trouble codes (DTC) are accessed using specific electronic devices interfaced to one or more separate electronic systems where still-functional electronic components are documented such that a purchase order can be placed with specificity when a consumer seeks a repair and according to OBD and DTC associated with the vehicle in need of a repair. For the sake of examination and patentability, it is clear that a general-purpose computer is incapable of performing the functional steps of the present invention, namely, to provide OBD and DTC analysis of every electronic system on a salvage vehicle so as to build a data set of still functional (and available) salvaged components along with OEM components so as, together, enable a repair procedure to be accomplished.

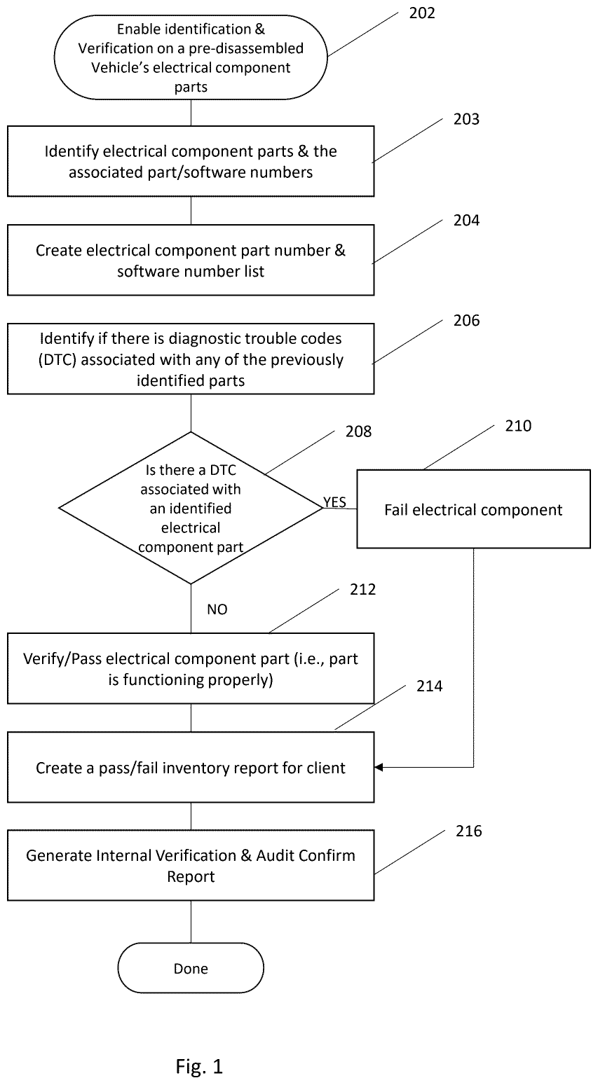

Now, the present invention will be described with specific reference to FIGS. 1 to 3. FIG. 1 is a flowchart depicting the methodology of identifying and verifying a salvaged vehicle's electrical parts and systems 200. As indicated at block 202, the mobile app 20 running on an electronic device 100 may be connected to and in communication with the OBD 32 of a salvaged vehicle 30 and may be configured to access each electronic part and system that may be installed on the respective salvaged vehicle 30. As indicated at blocks 203 and 204, the electrical component being scanned may be identified and a component part number may be assigned and stored. At block 206, a diagnostic trouble code associated with the identified electrical component may be identified and, if so, as identified at block 208, the identified component part is deemed to have failed (block 210). By contrast, if there is not a DTC associated with the identified electrical component part, then the identified electrical component part is verified to be functioning properly (block 212) and passes the test (block 214). Appropriate reporting may be made 216 accordingly and the part may be added to the data set 20 as indicated previously.

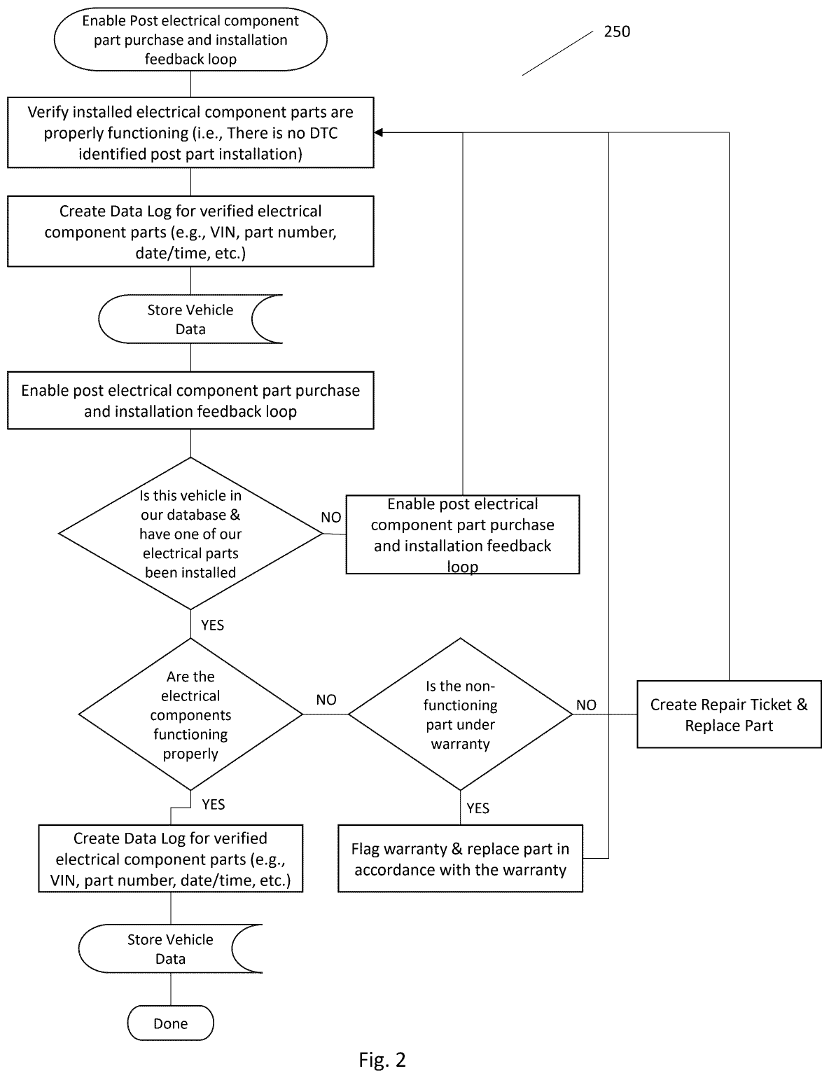

FIG. 2 illustrates a post electrical component part purchase and installation process 250 and, more particularly, verifies that electrical component parts have been ordered, installed, and are functioning correctly.

FIG. 3 is a flowchart that depicts a process 300 in which a vehicle in need of repair is analyzed to determine what electrical systems may be producing a diagnostic trouble code 302 and may produce a repair procedure 304 and, as a result, may prompt an order of a respective replacement part(s) 306. Ultimately, these actions allow the repair to be made by the vehicle owner or dealer 308.

It is understood that while certain forms of this invention have been illustrated and described, it is not limited thereto except insofar as such limitations are included in the following claims and allowable functional equivalents thereof.

1. A method for identifying and evaluating each electronic component part of a plurality of salvaged vehicles and for placing a purchase order of vehicle parts with which to repair a vehicle-in-need-of-repair, said method comprising:
identifying each electronic component part present on a respective salvaged vehicle by accessing onboard diagnostics (OBD) of said respective salvaged vehicle;
determining if a diagnostic trouble code (DTC) has been set by the OBD with respect to said each identified component part that is indicative that the identified electronic component part is still-functional and, if so, adding the identified electronic component part to a data set of still-functional salvage parts available for re-use along with an associated geographic address;
repeating the steps of (1) identifying each electronic component part and (2) determining whether the identified electronic component part is still-functional and, if so, adding the identified electronic component part to the data set of still-functional salvage parts until the plurality of salvaged vehicles has been evaluated;
using artificial intelligence algorithms in real time, determining a repair procedure on the vehicle-in-need-of-repair;
first, determining from the data set all of the still-functional salvage parts that correlate to said repair procedure and automatically ordering said correlated parts from respective geographic locations where said still-functional salvage parts are located;
second, determining a remainder of parts needed for said repair procedure that are not in said data set and automatically ordering said remainder set of parts from OEM sources.

2. The method as in claim 1, further comprising assigning a pedigree part number (PPN) to each still-functional salvage part in said data set.

3. The method as in claim 2, further comprising publishing said data set or a portion thereof to a third-party electronic marketing platform.

4. The method as in claim 3, wherein said electronic marketing platform is a reseller of automotive parts.

5. The method as in claim 4, further comprising updating said electronic marketing platform automatically and in real time whenever a respective still-functioning salvage part is added to said data set.

6. The method as in claim 1, further comprising using onboard diagnostics (OBD) of the vehicle-in-need-of-repair and diagnostic trouble codes (DTC) triggered thereby to determine a repair procedure and a purchase of replacement parts designed to repair said vehicle-in-need-of-repair.

7. (canceled)

8. The method as in claim 1, wherein said using artificial intelligence algorithms includes using predictive analytics to determine a failure date when respective electronic vehicle components are likely to fail and automatically placing an order for a corresponding OEM replacement part before said failure date.

9. The method as in claim 8, wherein said using artificial intelligence algorithms includes determining, ordering, and distributing respective said still-functional salvage parts that are determined to carry out said repair procedure on the vehicle-in-need-of-repair but ordering only a corresponding OEM part if a selected still-functional salvage part is determined to be likely to fail within a predetermined amount of time.

10. The method as in claim 9 wherein said using artificial intelligence algorithms includes accessing a neural network or large language model that has been updated and trained in real time to include respective repair procedures corresponding to respective diagnostic trouble codes (DTC's).

11. A system for identifying and evaluating each electronic assembly of a plurality of salvaged vehicles and for placing a purchase order of vehicle parts with which to repair a vehicle-in-need-of-repair, said system comprising:
a computing device having a processor in data communication with the Internet;
a memory in said computing device configured to store program instructions and a data set;
a vehicle controller interface (VCI) in data communication with said processor and with onboard diagnostics (OBD) of a respective salvaged vehicle so as to identify and to evaluate the functionality of an electrical component part of the respective salvaged vehicle, said VCI being configured to determine if said electrical component part is still-functional and, if so, directing said processor to store part data associated with the electrical component part in said data set;
wherein said processor is configured to use artificial intelligence algorithms to determine, order, and distribute a combination of OEM and said still-functional salvage parts as are required to carry out a repair procedure on the vehicle-in-need-of-repair.

12. The system as in claim 11, further comprising another vehicle controller interface (VCI) in data communication with said processor and with onboard diagnostics (OBD) of the vehicle-in-need-of-repair, said another VCI being in data communication with said processor and configured to determine respective diagnostic trouble codes indicative of a needed repair.

13. The system as in claim 11, wherein:
said processor is configured to repeatedly actuate said VCI to identify and evaluate the functionality of a plurality of electrical component parts of the respective salvaged vehicle, respectively, until all electrical component parts of the respective salvaged vehicle have been evaluated; and
wherein said processor is configured to repeatedly actuate said VCI to identify and evaluate the functionality of a plurality electrical component parts until all salvaged vehicles of said plurality of salvaged vehicles have been evaluated.

14. The system as in claim 11, wherein said using artificial intelligence algorithms includes using predictive analytics to determine a failure date when respective electronic vehicle components are likely to fail and automatically placing an order for a corresponding OEM replacement part before said failure date.

15. The system as in claim 14, wherein said using artificial intelligence algorithms includes determining, ordering, and distributing respective said still-functional salvage parts that are determined to carry out said repair procedure on the vehicle-in-need-of-repair but ordering a corresponding OEM part only if a selected still-functional salvage part is determined to be likely to fail within a predetermined amount of time.

16. The system as in claim 14, wherein said using artificial intelligence algorithms includes accessing a neural network that includes a large language model updated, trained, and configured in real time to include respective repair procedures corresponding to respective diagnostic trouble codes (DTC's).

17. The system as in claim 11, further comprising publishing said data set to a third-party electronic marketing platform.

18. The system as in claim 17, wherein said electronic marketing platform is a reseller of automotive parts.

19. The system as in claim 18, further comprising updating said electronic marketing platform automatically and in real time whenever a respective still-functioning salvage part is added to said data set.

20. The system as in claim 11, wherein said data set includes a database of functional salvage parts.
